(19) United States
(12) Patent Application Publication
(10) Pub. No.: US 2021/0323623 A1
(43) Pub. Date: Oct. 21, 2021

(54) CYCLE VEHICLES WITH ADJUSTABLE SEAT AND HANDLEBARS

(71) Applicant: Bond Mobility Inc., Zurich (CH)

(72) Inventors: Steven Howard Anderson, Irvine, CA (US); Erik Foster Buell, Mukwonago, WI (US); Daniel David Hurda, Mequon, WI (US); Edward Matthew Laben, Mukwonago, WI (US)

(21) Appl. No.: 17/233,051

(22) Filed: Apr. 16, 2021

Related U.S. Application Data
(60) Provisional application No. 63/011,057, filed on Apr. 16, 2020.

(51) Int. Cl. B62J 1/10; B62J 45/20; B62K 21/02; B62K 21/16; B62J 50/20

(52) U.S. Cl. CPC B62J 1/10; B62J 45/20; B62J 2001/085; B62K 21/16; B62J 50/20; B62K 21/02

(57) ABSTRACT

Aspects of the disclosure relate to saddle type vehicles having at least one seat and at least two wheels, at least one electric motor, and a rechargeable electric energy storage system, such as a battery and battery management system. A vehicle seat may be mounted on an adjustable inner seat post, where the adjustable movement may be vertical, substantially vertical, or at least partially vertical. Vehicle handlebars may be mounted on an inner shaft which allows movement parallel to the steering axis and is indexed to an outer steering stem that allows the handlebars, a chassis fork and front wheel to be steered together. In some examples, the inner seat post and handlebar inner shaft are electronically raised and lowered, for example by one or more electrical stepper motors, such that position of handlebars and seat may be selected by rider.

This application claims priority to and the benefit of U.S. Provisional Patent Application No. 63/011,057, filed Apr. 16, 2020, the above-identified application in incorporated by reference herein in its entirety.

### TECHNICAL FIELD

In some aspects, this disclosure relates to cycle vehicles, such as a saddle vehicle, and/or two-wheeled cycle vehicles. The cycle may be a human powered bicycle, an electronic bicycle partially powered by an electronic motor, or other vehicles such as motorcycles. The cycle may have electronically adjustable handlebars and electronically adjustable seat to provide for comfortable use by a wide range of users, for example when the cycle is part of a shared fleet that is used/rented by a variety of users for limited periods.

### BACKGROUND

The need to reduce environmental pollution is driving the replacement of internal combustion vehicles with vehicles having electric systems. Advances in rechargeable electric energy storage systems (RESS) and electric motor technologies have facilitated the use of electric vehicles are for all types of wheeled transportation. The use of shared two wheeled electric cycles (“e-cycles”) is becoming a large part of such transportation solutions, particularly in urban areas, among other applications. Shared bicycle fleets, however, present difficulties for users given the variety of individuals seeking to utilize these services. This not only requires that ride share services have e-cycles in a number of sizes, it requires that the user manually adjust the cycle seat to try to get a safe and comfortable riding position. As handlebars are not adjustable, typically several sizes of bicycle are required to get even mediocre riding fit. Poor fit can make the experience unenjoyable for a user and decrease future use. Varying cycle sizes also increases the number of vehicles needed for a ride share fleet, and also increases the waste of excess vehicles sitting.

### SUMMARY

This Summary provides an introduction to some general concepts relating to this disclosure in a simplified form, where the general concepts are further described below in the Detailed Description. This Summary is not intended to identify key features or essential features of the disclosure.

Some aspects of the disclosure related to a cycle vehicle. The cycle may include a seat assembly coupled to a cycle frame, the seat assembly including a seat positioned at a first seat height above a seat coupling. The cycle may include a handlebar assembly coupled to the cycle frame, the handlebar assembly including handlebars positioned at a first handlebar height above a handlebar coupling. The cycle may include one or more power sources, such as but not limited to one or more batteries, and may include one or more motors, for example a motor coupled (whether directly or indirectly) to the seat assembly that may drive movement of the seat, and a motor coupled (whether directly or indirectly) to the handlebar assembly that may drive movement of the handlebars.

In some examples, the seat assembly, the one or more power sources, and the one or more motors are configured to move the seat to at least a second seat height above the seat coupling. In certain embodiments, the handlebar assembly, the one or more power sources, and the one or more motors are configured to move the handlebars to at least a second handlebar height above the handlebar coupling.

In various examples, the seat assembly, the one or more power sources, and the one or more motors are configured to move the seat linearly between the first seat height and the at least second seat height (and/or along a range of possible seat height positions vertically or along a tilted but still substantially vertical axis). In some embodiments, the handlebar assembly, the one or more power sources, and the one or more motors are configured to move the handlebars linearly between the first handlebar height and the at least second handlebar height (and/or along a range of possible handlebar height positions vertically or along a tilted but still substantially vertical axis).

In some embodiments, the one or more motors are electric stepper motors. The stepper motor(s) may drive defined rotation of a threaded piece, such as a screw, that will result in linear translation or other movement of a component that is directly or indirectly coupled to the threaded piece. In some examples, the one or more motors are configured to rotate a seat assembly threaded component to provide linear height adjustment of the seat. In certain embodiments, the one or more motors are configured to rotate a handlebar assembly threaded component to provide linear height adjustment of the handlebars.

In various examples, the handlebar assembly includes two or more telescoping elongated members that are keyed together. In certain examples, at least one member may move linearly along an axis defined by the center of the elongated members, but that the members are rotatably coupled, and will rotate together regardless of the extent of the elongation provided by position of the two or more members.

In certain embodiments, the handlebar assembly includes a fork coupling the handlebars and a wheel, and least a portion of the fork provides a center defining a steering axis. In some examples, the first handlebar height and the at least second handlebar height are based on the position of a centerpoint of the handlebars, and the first handlebar height and the at least second handlebar height are different positions along the steering axis or different positions along a handlebar centerpoint axis that is parallel to the steering axis.

In various examples, the handlebar assembly includes a fork coupling the handlebars and a wheel, at least a portion of the fork provides a center defining a steering axis, and the seat assembly includes a seat extension coupling the seat and the frame. In certain examples, at least a portion of the seat extension provides a center defining a seat axis, and the steering axis is offset by between around twenty and around thirty degrees from a perpendicular orientation to the ground when the cycle is upright and placed on a flat surface. In some embodiments, the seat axis is offset by between around twenty and around thirty degrees from a perpendicular orientation to the ground when the cycle is upright and placed on a flat surface.

In certain embodiments, the cycle further includes one or more electronic controllers, where the one or more controllers and one or more motors may be configured to adjust the seat height and handlebar height, based on position input received by the one or more electronic controllers.

In various embodiments, the frame, seat assembly, and handlebar assembly are sized and shaped such that any wires, any cables, and any hoses used to connect the one or more electronic controllers, the one or more power sources, the one or more motors, and any brake components to each other are contained within an interior area provided by the frame, the seat assembly, and the handlebar assembly.

In some examples, the one or more electronic controllers are coupled to the frame, and are configured to receive position input through one or more controller inputs. In certain embodiments, one or more electronic controllers are configured to interface with an external computing device through a wireless data connection and receive position input provided by the external computing device.

In some examples, the one or more electronic controllers include at least one processor, a communication interface communicatively coupled to the at least one processor, and memory storing computer-readable instructions that, when executed by the at least one processor, cause the one or more electronic controllers to establish a wireless data connection with an external computing device. Then, the one or more electronic controllers may receive position input data from the external computing device, identify an adjusted seat height based on the position input data, and then activate the one or more motors to move the seat to the adjusted seat height. The one or more electronic controllers may also identify an adjusted handlebar height based on the position input data, and then activate the one or more motors to move the handlebars to the adjusted handlebar height.

In some examples, position input data is a size selected by a cycle rider, e.g. small, medium, large, and so on. In certain embodiments, the position input data inlcudes one or more of a cycle rider height, a cycle rise inseam length, or one or more cycle rider customization inputs (e.g. a riding style preference). In certain embodiments, the external computing device includes a rider database storing a plurality of cycle rider profiles, the cycle rider profiles including position input data (e.g. height and/or inseam measurements) and personal electronic device data (e.g. account name and/or phone number used to reserve a cycle vehicle).

Some aspects of the disclosure are related to methods. In one aspect, a method of adjusting the positions of a seat and handlebars of a cycle vehicle is provided. The method, in some examples, includes receiving, at a computing platform having at least one processor, a communication interface, and memory, a vehicle reservation request from a personal electronic device. Then, the computing platform may identify a cycle rider profile stored in a rider database provided in the memory, based on identifying information provided by the personal electronic device. The platform may then identify position input data based on the cycle rider profile, and then transmit the position input data to one or more electronic controllers of a cycle vehicle. In this manner, the cycle may then adjust the seat and/or handlebars of the cycle prior to pick-up by the user. In some examples, the method further includes transmitting a location of the cycle vehicle to the personal electronic device. In certain embodiments, the cycle rider profile includes one or more of a cycle rider height, a cycle rise inseam length, or one or more cycle rider customization inputs.

In another aspect, a method of adjusting the positions of a seat and handlebars of a cycle vehicle is provided. In some examples, the method includes receiving, at a computing platform comprising at least one processor and a communication interface, position input data (e.g. from a graphical user interface provided on the cycle, for example through a touchscreen and/or switches, or via a computing device that transmits user entered input). The method may then include adjusting a cycle seat from a first seat height to a second seat height, based on the position input data, by activating one or more motors powered by one or more power sources. The method may also include adjusting cycle handlebars from a first handlebar height to a second handlebar height, based on the position input data, by activating the one or more motors powered by the one or more power sources.

In some examples, the method further includes identifying, based on the position input data, the second seat height and the second handlebar height. In certain embodiments, the position input data includes one or more of a cycle rider height, a cycle rise inseam length, or one or more cycle rider customization inputs.

Through these aspects, cycle vehicles may provide a range of handlebar and seat positions that would provide comfort for the majority of riders, and provide efficient adjustment of the same.

These and other features, advantages, and objects of the present disclosure will be further understood and appreciated by those skilled in the art by reference to the following specification, claims, and appended drawings, where various embodiments of the design illustrate how concepts of this disclosure may be used in cycle vehicles, such as pedaled or non-pedaled e-cycles.

### BRIEF DESCRIPTION OF THE DRAWINGS

Other characteristics and advantages of the present disclosure will become more evident from the description of several embodiments of an e-cycle, which serve as illustrative examples but do not limit the disclosure's scope to other configurations. Example embodiments of the disclosure will now be described by way of example only and with reference to the accompanying drawings, in which:

FIG. 1 illustrates an external view of an example embodiment of an electronic bicycle (“e-bicycle”) vehicle.

FIG. 2 illustrates an external view of an example embodiment of an e-bicycle vehicle with the seat and handlebars in highest positions.

FIG. 3 illustrates an external view of an example embodiment of an e-bicycle vehicle with the seat and handlebars in intermediate positions.

FIG. 4 illustrates an external view of an example embodiment of an e-bicycle vehicle with the seat and handlebars in lowest positions.

FIG. 5 illustrates a centerline cutaway view of the mid-section of an example embodiment of an e-bicycle vehicle, illustrating an example seat movement mechanism.

FIG. 6 illustrates a centerline cutaway view of the front section of an example embodiment of an e-bicycle vehicle, illustrating an example handlebar movement mechanism.

FIG. 7 illustrates a ghosted view of an example handlebar mechanism.

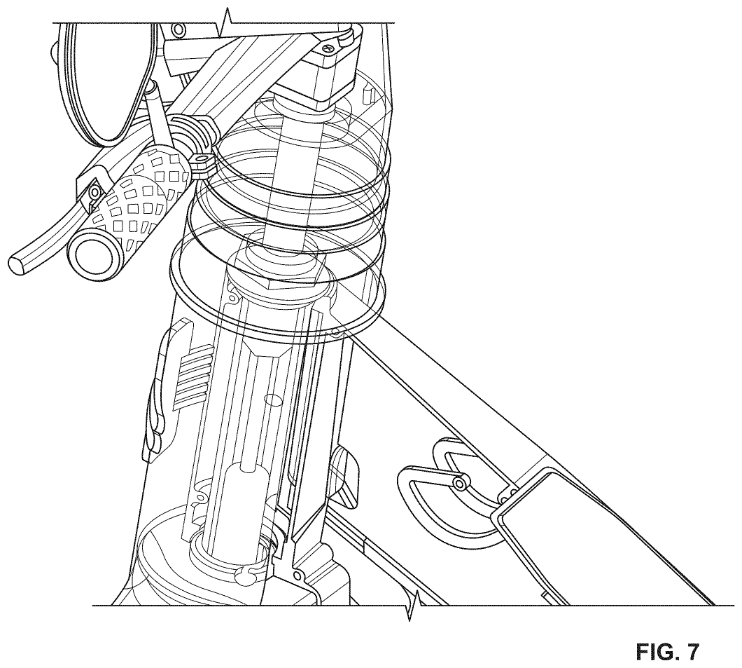

FIGS. 8-10 illustrates example display content provided to a rider, for example on a personal electronic device via a application administered by a vehicle ride share company (e.g. through a server or other external computing platform).

FIG. 11 illustrates example devices/platforms and example communication links between the same.

FIG. 12 illustrates a cutaway view of an example embodiment of an e-bicycle vehicle, illustrating an example handlebar movement mechanism.

FIG. 13 illustrates an example embodiment of an e-bicycle vehicle.

FIG. 14 illustrates an example embodiment of an e-bicycle vehicle, illustrating an example seat movement mechanism.

FIG. 15 illustrates an example embodiment of an e-bicycle vehicle, illustrating an example handlebar movement mechanism.

### DETAILED DESCRIPTION

In the following description of the various embodiments, reference is made to the accompanying drawings, which form a part hereof, and in which is shown by way of illustration various embodiments in which aspects described herein may be practiced. It is to be understood that other embodiments may be utilized and structural and functional modifications may be made without departing from the scope of the described aspects and embodiments. Aspects described herein are capable of other embodiments and of being practiced or being carried out in various ways. Also, it is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof. The use of the terms “mounted,” “attached,” “fixed,” “connected,” “coupled,” “positioned,” “engaged” and similar terms, is meant to include both direct and indirect mounting, attaching, fixing, connecting, coupling, positioning and engaging.

Also, while the terms “top,” “bottom,” “front,” “back,” “left,” “right,” “side,” “rear,” “upward,” “downward,” and the like may be used in this specification to describe various example features and elements of the disclosure, these terms are used herein as a matter of convenience, e.g., based on the example orientations shown in the figures or the orientation during typical use. Additionally, the term “plurality,” as used herein, indicates any number greater than one, either disjunctively or conjunctively, as necessary, up to an infinite number. Nothing in this specification should be construed as requiring a specific three-dimensional orientation of structures in order to fall within the scope of this disclosure.

It is also to be understood that the specific devices and/or processes illustrated in the attached drawings, and/or described in the following specification, are simply example embodiments. Hence, specific dimensions and other physical characteristics relating to the embodiments disclosed herein are not to be considered as limiting. Moreover, the figures of this disclosure may represent the scale and/or dimensions according to one or more embodiments, and as such contribute to the teaching of such dimensional scaling. However, the disclosure herein is not limited to the scales, dimensions, proportions, and/or orientations shown in the figures. Similarly, the materials and processes illustrated in the attached drawings, and described in the following specification, are simply example embodiments of the concepts defined in the appended claims. Hence, specific dimensions and other physical characteristics relating to the embodiments disclosed herein are not to be considered as limiting unless explicitly stated to be so.

Aspects of this disclosure relate to cycles, e-cycles, and/or other saddle type vehicles. The vehicle may have a chassis containing and/or providing components that provide adjustability of the seat and handlebars through a substantial range of positions. The cycle may include a seat assembly coupled (directly or indirectly) to a cycle frame, the seat assembly including a seat positioned at a first seat height above a seat coupling. The cycle may include a handlebar assembly coupled to the cycle frame, the handlebar assembly including handlebars positioned at a first handlebar height above a handlebar coupling. The cycle may include one or more power sources, such as but not limited to one or more batteries, and may include one or more motors. A cycle may include one or more storage compartments designed to hold one or more batteries. A battery storage compartment or compartments may include a locking mechanism to limit persons that can access, replace, and/or repair batteries and/or other power sources.

For example, a cycle may include a motor coupled (whether directly or indirectly) to the seat assembly that may drive movement of the seat, and a motor coupled (whether directly or indirectly) to the handlebar assembly that may drive movement of the handlebars. The adjustment may be powered or unpowered (in whole or in part, e.g. one of the handlebars or seat adjustment systems are fully or partially powered, and the other in unpowered and/or only partially powered). Unpowered systems may use latching or other locking mechanisms to secure components at a desired height, and may notching or other features to map corresponding handlebar and seat positions (e.g. lowest notch corresponding to a lowest position of the other of the seat/handlebars, a second lowest notch corresponding to the next position upward, and so on).

While the adjustment systems may be electrically powered, other systems using hydraulic and pneumatic components may also be used. In some examples, the seat assembly, the one or more power sources, and the one or more motors are configured to move the seat to at least a second seat height above the seat coupling. In certain embodiments, the handlebar assembly, the one or more power sources, and the one or more motors are configured to move the handlebars to at least a second handlebar height above the handlebar coupling.

The adjustment of the seat and handlebars may facilitate a comfortable fit for wide range of rider sizes and/or anthropomorphic measurements that can be accommodated with one main frame size. The adjustment capability may provide a range of handlebar and seat positions that would address the majority of riders. The movement may be linear or near linear, but in some examples may be provide along a curved path, including on a path with a constant radius. For example, placing the seat on cantilever structure would provide movement along the path of an arc.

In some examples, the movement of the handlebars may be along a linear axis that is colinear to or parallel to a steering angle axis defined by the angle of steering components. In certain examples, the movement of the handlebars may be along a linear axis that is near, but not colinear to or parallel to a steering angle axis (for example, but not limited to, within about 0.5 degrees or within about 1 degree). In some examples, the movement of the seat may be along a linear axis with the same or a similar angle as compared to the steering angle axis and/or the movement axis of the handlebars. In some examples, the axes of movement for the handlebars and the seat are the same or nearly the same. In certain examples, the axes are within about one degree or less to each other, two degrees or less to each other, three degrees or less to each other, or about four degrees or less to each other, or about five degrees or less to each other, or about 7.5 degrees or less to each other. In certain examples, the axes are within about 0-1 degrees to each other, about 0-2 degrees, about 0.5-1.5 degrees, about 0.75-1.25 degrees, about 0-3 degrees, about 0-2.5 degrees, about 0-5 degrees, or about 0-10 degrees to each other. In some examples, the angles may be based at least in part on frames designed for city cycle use, while in others mountain/trial cycle use.

In certain examples, use of a range of positions along movement axes, such as by moving the handlebars parallel to the steering angle, and providing a seat post with motion along a non-vertical angle, provides seat and handlebar positions comfortable to riders over a 45 cm height difference range, or about a range of about 40 or more cm, or about 35 cm or more, or about 30 cm or more, or about 50 cm or more. In some examples, the positions and angles will be selected using the ideal placement of seat/handlebars for a range of riders from about 4′10″ in height to about 6′6″ in height.

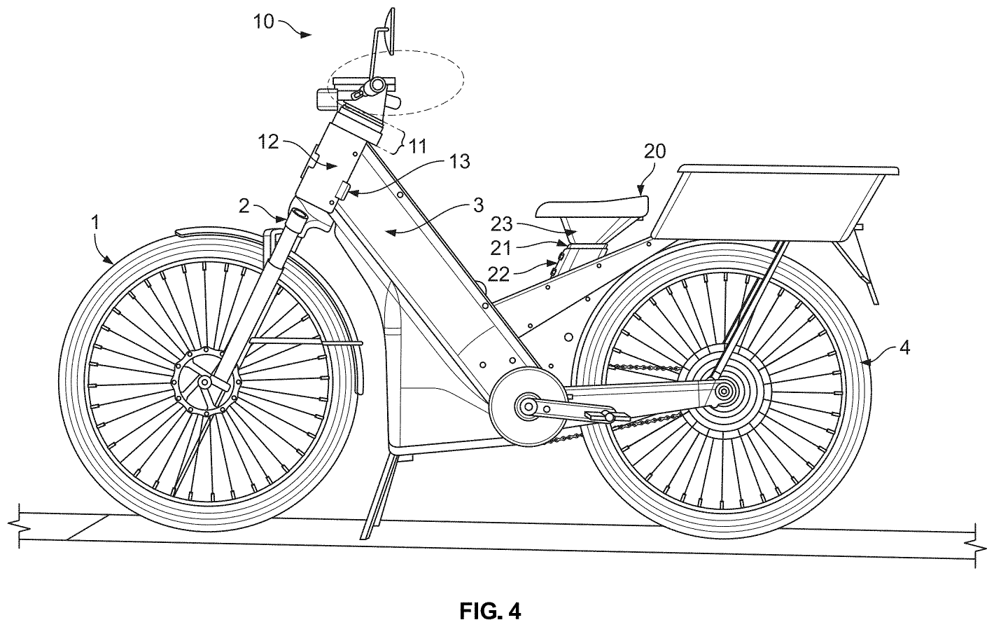

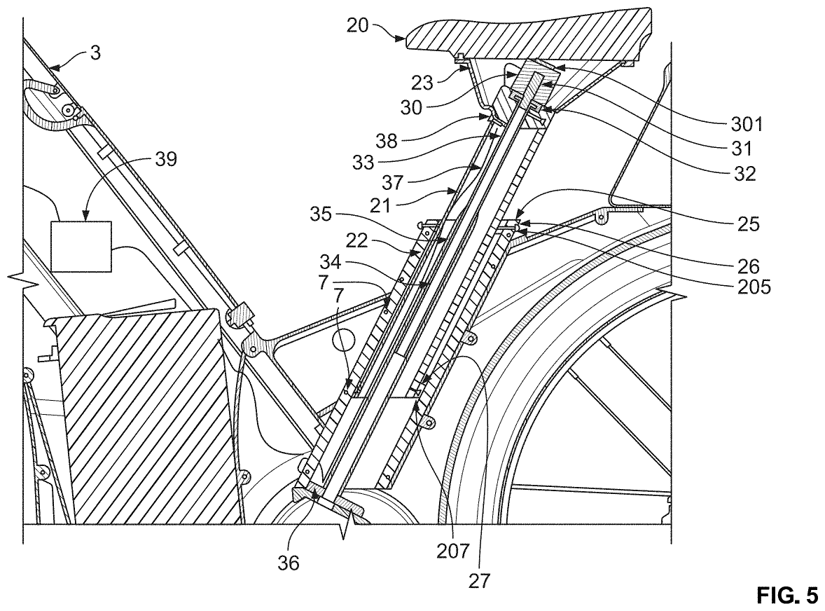

In various embodiments, each of the seat and handlebars may have a range of allowed movement (based on the characteristics of the seat/handlebar assemblies, e.g. any screw and/or post components) that is about 100 mm or more, or about 150 mm or more, or about 175 mm or more, or about 200 mm or more, or about 225 mm or more. In some examples, the ranges for one and/or both of the seat and handlebars may be about 175-250 mm, about 200-250 mm, about 210-230 mm, or about 220-230 mm. In certain embodiments, the range of allowed movement is about 75-125 mm for the handlebars, or about 75 mm or more, or about 125 mm or less, or about 90-110 mm, or about 90 mm or more. In certain examples, the range of allowed motion for the seat is about 150 mm or more, about 200 mm or more, about 210 mm or more, or about 220 mm or more, or about 215-225 mm. The starting and ending points, and utilized angles for the range of motion (e.g. the offset from a perfectly vertical axis of linear movement) may correspond at least in part to a best fit linear plot of the possible minimum, median, and maximum positions (and/or a subset thereof) of handlebars and seats for each of a small, medium, and large cycle frame sizes (or other available sizes if there are additional or different categorizations). The range of motion may be measured from the end point of the cycle frame, or the endpoint of an adjacent coupling piece extending from the frame. In some examples, the starting point of the motion from the lowest position may be within about 10 cm of the frame, within about 20 cm of the frame, within about 30 cm of the frame, or within about 40 cm of the frame, and/or these distances with respect to a connected piece to the frame, that, e.g. a post enters into, such as outer seat post 22 shown in the example of FIG. 5. In some examples, the seat and/or handlebars may be flush with the frame and/or a connected piece to the frame (like outer seat post 22 shown in the example of FIG. 5). In some examples, the starting point of motion from the lowest position for the handlebars may correspond to a position when the telescoping cover 11 or a similar components is in the smallest configuration possible, as illustrated in an example of FIG. 4.

Movement through the range of possible positions may be achieved by moving the seat and handlebars linearly and/or in a substantially linear path. The motion may be driven by electric stepper motors, for example by rotating screws which raise and lower the handlebars and seat individually (although this rotary motion may be provided without stepper motors). In other examples, a multi-bar linkage (e.g. a four-bar linkage) could provide a scissor-like jack design (e.g. a four-bar linkage with two sets of beams, joined by a hex nut or other coupling mechanism) that would result in relative linear or near linear motion.

In various examples, the seat assembly, the one or more power sources, and the one or more motors are configured to move the seat linearly between the first seat height and the at least second seat height (and/or along a range of possible seat height positions vertically or along a tilted but still substantially vertical axis). In some embodiments, the handlebar assembly, the one or more power sources, and the one or more motors are configured to move the handlebars linearly between the first handlebar height and the at least second handlebar height (and/or along a range of possible handlebar height positions vertically or along a tilted but still substantially vertical axis).

In some embodiments, the one or more motors are electric stepper motors. The stepper motor(s) may drive defined rotation of a threaded piece, such as a screw, that will result in linear translation or other movement of a component that is directly or indirectly coupled to the threaded piece. In some examples, the one or more motors are configured to rotate a seat assembly threaded component to provide linear height adjustment of the seat. In certain embodiments, the one or more motors are configured to rotate a handlebar assembly threaded component to provide linear height adjustment of the handlebars.

In some examples, the design provides design feature(s) which allow wires, cables and hoses coming from the handlebars to move as the handlebars move, as well as organize and protect these components from outside accidental damage or vandalism. For example, the frame and/or any coupling components may have a sufficient diameter/width and shape to allow internal routing of wires and the like. The frame and/or chassis may comprise one or more metals or metallic alloys. In some examples, the frame and/or chassis includes two cast halves that are essentially mirror images of each other, which are joined with internal components contained within. The frame and/or chassis may also be molded or otherwise assembled. In some examples, the vehicle has a chassis constructed of castings, moldings or stampings.

Thus, in various embodiments, the frame, seat assembly, and handlebar assembly may be sized and shaped such that any wires, any cables, and any hoses used to connect the one or more electronic controllers, the one or more power sources, the one or more motors, and any brake components to each other are contained within an interior area provided by the frame, the seat assembly, and the handlebar assembly. In some examples, any wires and/or brake hose from handlebar control area are routed down through a hollow telescoping and rotatable housing into a hollow housing fixed around steering head of frame with exit from this for wires, hoses and/or cables entering the frame. A handlebar cover may also provide for wire and hose protection. For example, any wires, hoses etc. may be routed through a recess or cavity of the handlebars, and a removeable cover is placed over the recess and/or an access area of the cavity, to allow selective access to these components.

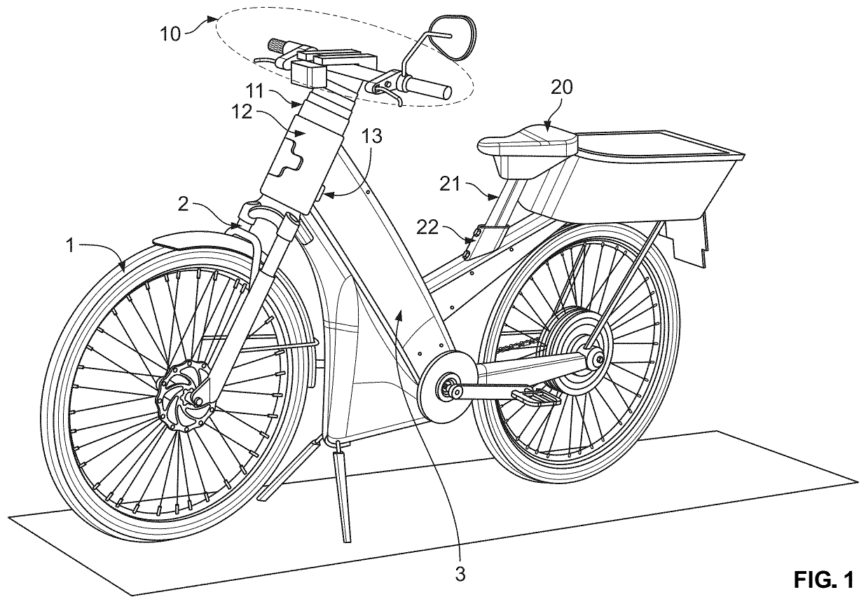

As shown in the example embodiment of FIG. 1, an e-cycle chassis 3 has a front steerable structure including fork 2 connecting handlebars 10 to wheel/tire 1, where this structure rotates about the axis represented by the centerline through the round dimensions of wire housing 12 and telescoping cover 11. Handlebar assembly 10 can move linearly along the aforesaid axis. Seat assembly 20 is fixed to inner seat post 21, which can slide along its axis inside outer seat post 22. The handlebars and/or seat may be slidably actuated, such example by connection to a post component and/or other elongated component that may slidably actuate through/within a cavity or opening of the frame or a piece coupling the e.g. post to the frame. This actuation/movement may be driven in a number of ways, including through use of one or more rotating threaded components, multi-component linkages, pivot shafts, crankshafts, piston/connecting rods, pistons, actuable cylinders (or other similar components with non-cylindrical shapes) such as pneumatic cylinders and/or hydraulic cylinders, may be used,

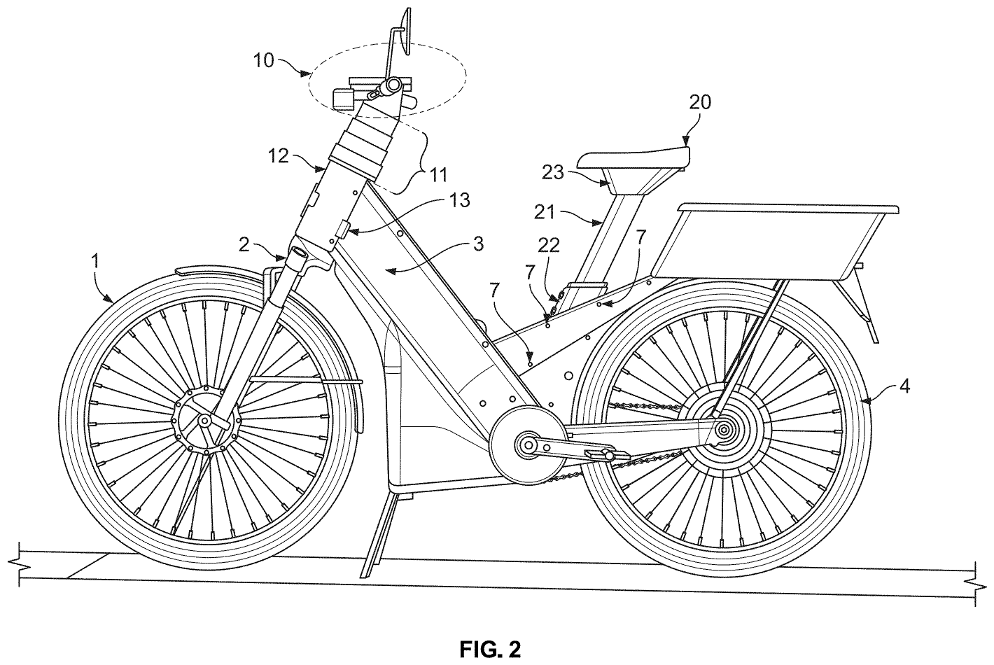

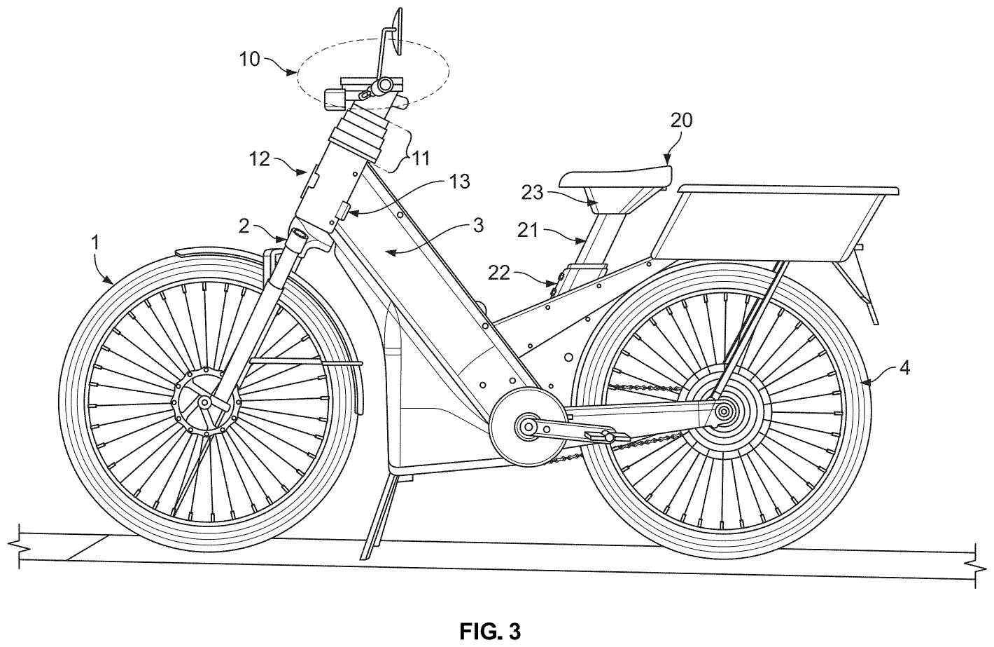

In the example embodiments of FIGS. 2-4, an example range of adjustability motion of handlebars 10 and seat 20 relative to frame 3 is shown. The example of FIG. 2 illustrating highest position of both, the example of FIG. 3 representing mid-range position, and the example of FIG. 4 representing lowest position (but other numbers of possible positions may be used, for example 3 or more, 5 or more, or 7 or more). The example of FIG. 2 also shows the location of fasteners 7 which affix outer seat post 22 to main frame 3. Other coupling methods are possible, however.

The example of FIG. 5 shows a centerline section of a vehicle which is used to illustrate one embodiment of the mechanism of the adjustable seat. In this example, inner seat post 21 slides inside outer seat post 22 on upper bushings 25. The bushing(s) may be inserted into outer post cap 26 with fasteners 205, as shown here. The seat post may also slide using lower bushings, e.g. bushings 27 which are fixed to inner post 21 with fasteners 207. The bushings may be in a fixed position, for example at a fixed height within the cap. One or more bushings may be a circular shape or other shape, such as a hexagonal shape or other polygonal shape. In some examples, the upper bushings are at a fixed height but the lower bushings (or vice versa) may travel with the inner stem.

In this example, motion of inner post 21 is driven by seat stepper motor 30 which is attached to seat mount casting 23 by cross brace 301. Seat mount casting 23 is attached to inner seat post 21 with fasteners 38. The stepper motor receives power and also activation signals from electronic controller 39 through wire harness 37. When activated, stepper motor inner shaft 31 rotates, and shaft 31 is keyed into seat adjuster screw 33 such that screw 33 also rotates. Seat adjuster screw 33 has external threads which engage with internally threaded seat support rod cap 35. Cap 35 is permanently fixed to hollow seat support rod 34, which is externally threaded at the base and screws into frame mount plate 36, which is affixed to main frame housing 3. As seat adjuster screw 33 rotates, inner seat post 21 moves up or down depending on selected rotation of stepper motor 30. The bushings may be a unitary piece or multi-assembled pieces, such as two halves that are assembled around the appropriate components. The bushings may include or consist of one or more thermoplastic materials, one or more metals, and/or one or more metallic alloys (e.g. bronze).

In various examples, the handlebar assembly includes two or more telescoping elongated members that are keyed together. In certain examples, at least one member may move linearly along an axis defined by the center of the elongated members, but that the members are rotatably coupled, and will rotate together regardless of the extent of the elongation provided by position of the two or more members. In certain embodiments, the handlebar assembly includes a fork coupling the handlebars and a wheel, and least a portion of the fork provides a center defining a steering axis. In some examples, the first handlebar height and the at least second handlebar height are based on the position of a centerpoint of the handlebars, and the first handlebar height and the at least second handlebar height are different positions along the steering axis or different positions along a handlebar centerpoint axis that is parallel to the steering axis.

In various examples, the handlebar assembly includes a fork coupling the handlebars and a wheel, at least a portion of the fork provides a center defining a steering axis, and the seat assembly includes a seat extension coupling the seat and the frame. In certain examples, at least a portion of the seat extension provides a center defining a seat axis, and the steering axis is offset by between around twenty and around thirty degrees from a perpendicular orientation to the ground when the cycle is upright and placed on a flat surface. In some embodiments, the seat axis is offset by between around twenty and around thirty degrees from a perpendicular orientation to the ground when the cycle is upright and placed on a flat surface.

In some examples, the handlebars are provided by a one piece casting, which may be hollow on top, where a cover (such as a thermoplastic cover) may go over the gap in the casting. Any cavity in the handle bars may include one or more communication components (e.g. that can provide a wireless data connection, as described below). The handlebars may include a display area, for example a display area indicating speed and/or battery life. The display areas may utilize one or more light-emitting diodes.

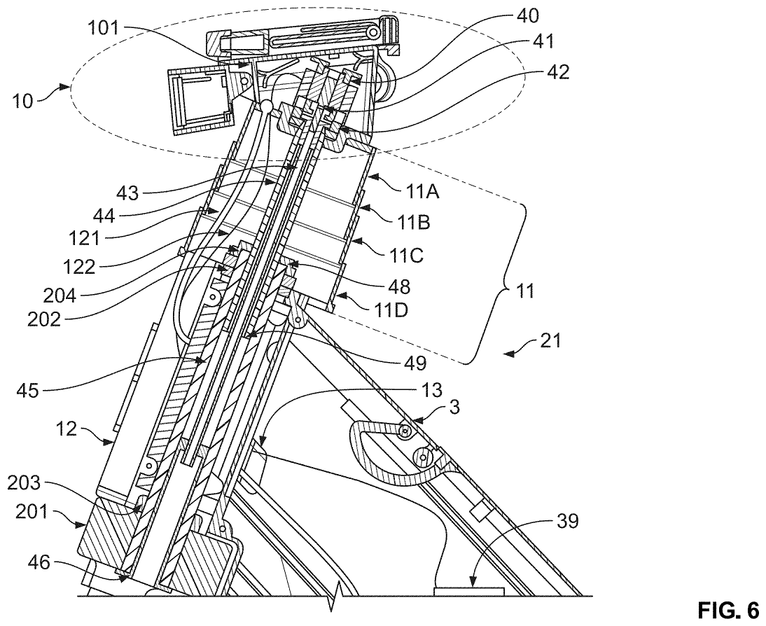

The example of FIG. 6 shows a centerline section of the vehicle which is used to illustrate one embodiment of the mechanism of the adjustable handlebars. In this example, inner steer stem 44 slides inside outer steer stem 45 on upper bushings 48 which are captured between outer stem 45 and stem nut 204. Inner stem 44 is keyed to outer stem 45 such that turning inner stem 44 about its axis turns outer stem 45 along with it. “Key” or “keyed” in this disclosure means structured to allow for relative linear motion. As one example, there may be an external hex on inner stem 44 and slightly larger (for clearance) internal hex on outer stem 45. Or it may be accomplished by any other structures, or shapes (e.g. other polygonal shapes, or use of one or more faces that are flat or substantially flat, or through other coupling features such as a tab/detents, or a groove with a corresponding ridge that fits within the groove, etc.) that permits motion between 44 and 45 linearly on the axis, but does not allow rotational movement between 44 and 45 about said axis, or only allows limited rotational movement.

In this example, outer stem 45 rotates about its axis on upper bearing set 202 and lower bearing set 203. Outer stem 45 is pressed into fork bridge 201, to which front suspension legs and front wheel are attached. Outer stem 45 is inserted through bearing sets and retained in place by stem nut 204. Inner stem 44 is attached at the top to handlebar casting 101 in a fashion where handlebars and inner stem are locked together to rotate as one about the steering stem axis, yet 41 can move linearly on its axis.

As illustrated by this example, linear motion of inner stem 44 may be driven by handlebar stepper motor 40 which is attached to handlebar casting 101. Stepper motor receives power and also activation signals from electronic controller 39 through wire harness 204. When activated, stepper motor inner shaft 41 rotates, and shaft 41 is keyed into handlebar adjuster screw 43 such that screw 43 also rotates on bearing set 42. Handlebar adjuster screw 43 has external threads which engage with internally threaded stem insert 46, for example at the top of the insert (which spans the internal cavity) as illustrated in FIG. 6 near the bottom of the adjuster screw 43. Insert 46 is permanently fixed to outer stem 45, but in other examples may be removably fixed. As adjuster screw 43 rotates, inner stem 44 moves linearly on its axis depending on selected rotation of stepper motor 40.

As handlebar casting 101 and attached components (10) move linearly, the nested cover segments 11A, 11B, 11C and 11D slide to maintain enclosure of all mechanical components as well as wire harness 122 and hose, wire and cable harness 121. As these harnesses exit the bottom of the nested cover assembly 11 they continue to be enclosed inside whose and wire cover 12, and those which need to attach to components rear of the steering head exit the housing and enter the frame at 13. Nested cover assembly segment 11A is attached to handlebar casting 101, and nested cover segment 11D is snapped to hose and wire housing 12.

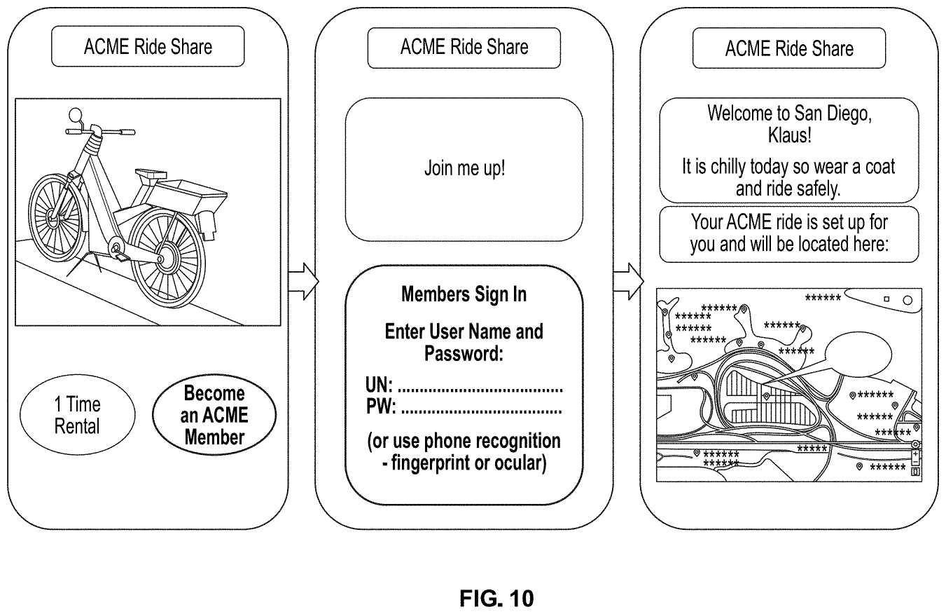

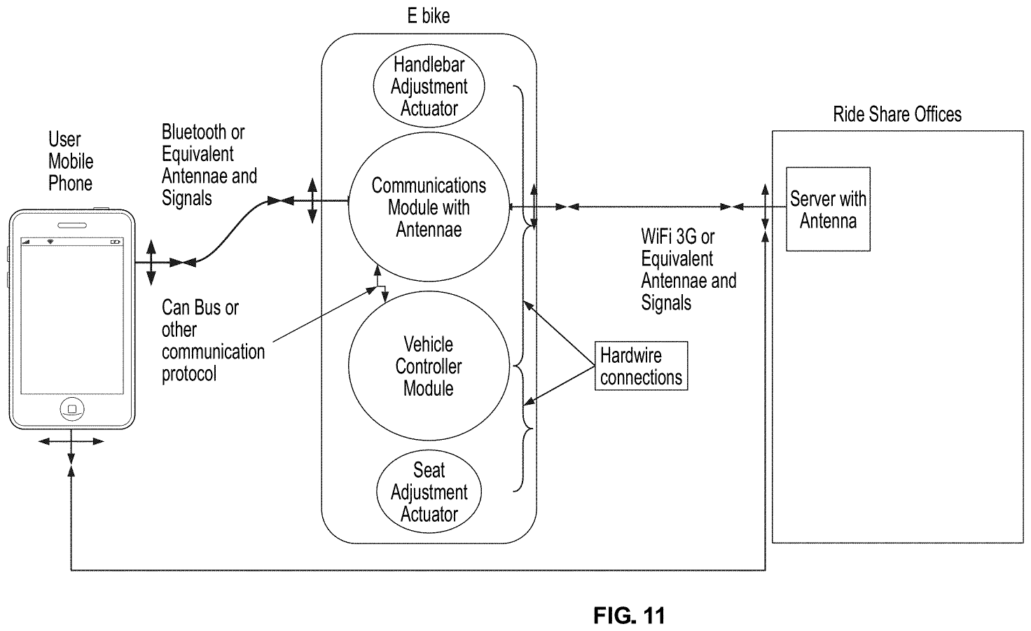

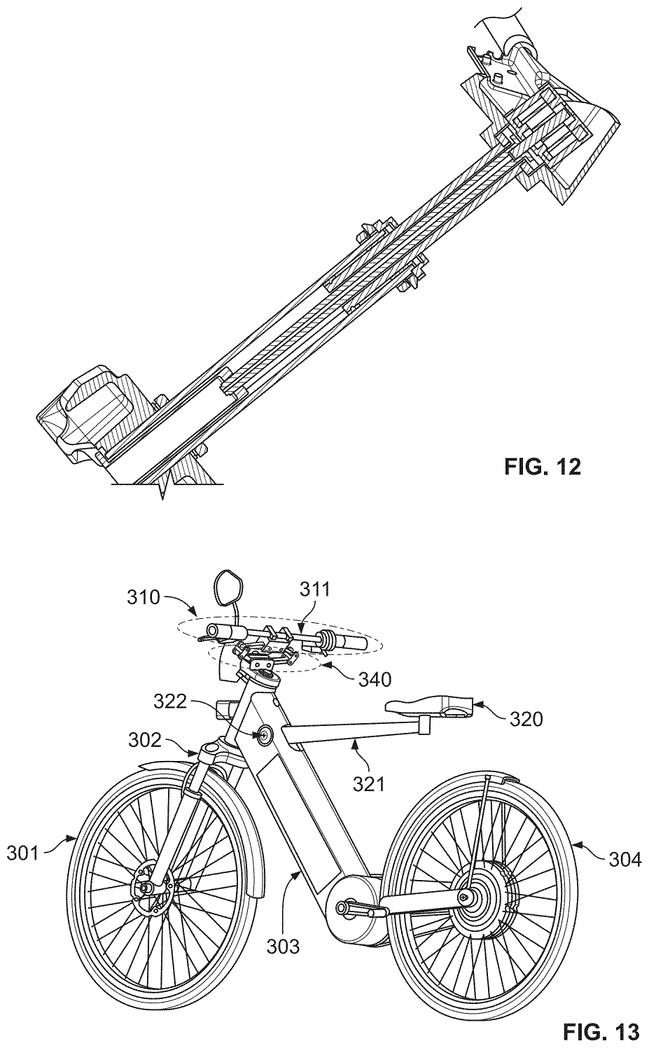

FIG. 12 is another view of example steering adjustment mechanism components. FIG. 13 illustrates an alternative embodiment of adjustable seat and handlebars, where seat 320 is raised and lowered by rotation about a pivot shaft 321, and handlebar control assembly 310 is raised and lowered by a linkage assembly 340. FIG. 14 illustrates the mechanism of the seat adjustment for the vehicle in FIG. 13. Seat mounting arm 321 rotates about shaft 322 on bearings mounted in arm hub 324. Shaft is mounted to frame 303 on mounts 323. Hub 324 has a rack gear radial segment 338 attached to it, and gear segment 338 is engaged with pinion gear 335. Pinion gear 335 is attached to fine tooth worm wheel gear 336 and both rotate on bearings about shaft 331. Worm pinion gear 333 has fine teeth and is mounted on the shaft of encoded servo motor 330. Rotation of motor 330 drives worm pinion gear 333, and thus drives pinion gear 335, which in turn moves rack gear segment and seat arm 321 around shaft 322, thus raising and lowering seat.

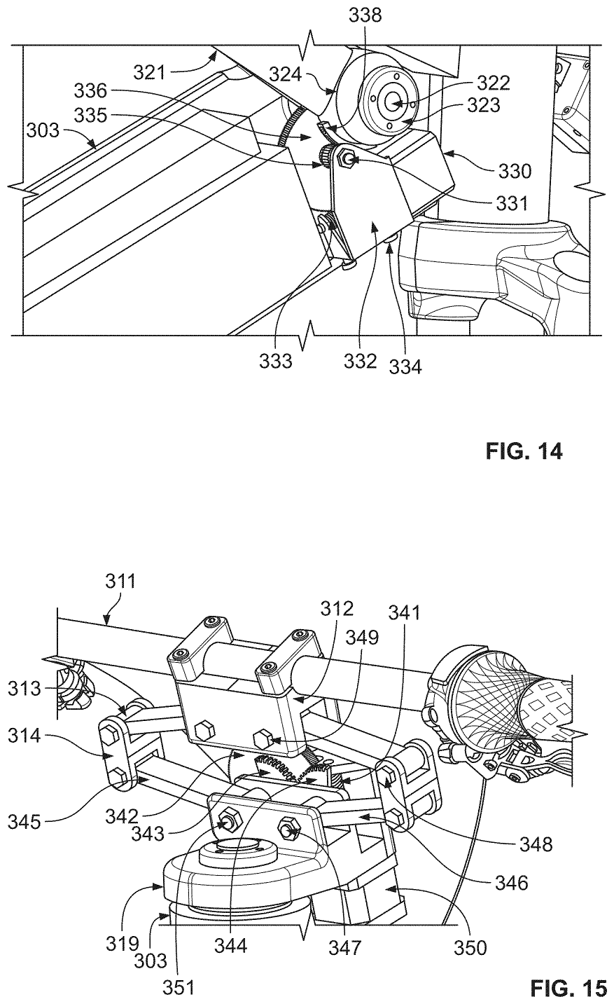

FIG. 15 illustrates the mechanism of the handlebar adjustment, e.g. for the vehicle in FIG. 13. Handlebar 311 is clamped to mount block 312. Mount block 312 has two floating adjustment arms 313 attached which rotate on bearings around the axes of mount block bolts 349. Opposite ends of arms 313 are attached to links 314 with link bolts 348 and can also rotate on axes of these bolts on bushings or bearings. Powered left arm 345 and right arm 346 also are mounted with axial rotation freedom at their outer ends to links 313 with link bolts 348. Powered left arm 345 is attached to main driven shaft 351 with splines or key such that these two components are linked and both rotate around the axis of shaft 351 on bearings in lower steering block 319. Main driven shaft 351 is attached to driver gear segment 343 and worm wheel gear 342 such that rotation of these gears moves powered left arm 345 about the axis of shaft 351. Worm wheel gear 342 is driven to rotation around main driven shaft axis by worm pinion gear 341 which is fixed to the shaft of encoded servo motor 350. As worm wheel gear rotates, so does driver gear segment 343, which is meshed with driven gear segment 344, which is fixed to auxiliary shaft 347, causing driven gear and auxiliary shaft to rotate in the opposite direction of driven shaft 351 and attached powered left arm 345. Powered right arm 346 is attached to auxiliary shaft 347 with a spline and/or key so it also rotates in opposite direction of powered left arm 345. As these two powered arms are driven in opposite directions, they cause handlebars 311 to raise and lower through motion of arms and link. A similar mechanism may be used for the seat as well.

In the above embodiments and related figures, various components are used and described. Components, shapes, configurations etc. from one embodiment may be applied to another, and modifications (e.g. size, orientation, etc.) may be made thereto to accomplish the desired movements.

In certain embodiments, the cycle further includes one or more electronic controllers, where the one or more controllers and one or more motors may be configured to adjust the seat height and handlebar height, based on position input received by the one or more electronic controllers. In some examples, the one or more electronic controllers include at least one processor, a communication interface communicatively coupled to the at least one processor, and memory storing computer-readable instructions that, when executed by the at least one processor, cause the one or more electronic controllers to establish a wireless data connection with an external computing device. Then, the one or more electronic controllers may receive position input data from the external computing device, identify an adjusted seat height based on the position input data, and then activate the one or more motors to move the seat to the adjusted seat height. The one or more electronic controllers may also identify an adjusted handlebar height based on the position input data, and then activate the one or more motors to move the handlebars to the adjusted handlebar height.

In some examples, position input data is a size selected by a cycle rider, e.g. small, medium, large, and so on. In certain embodiments, the position input data includes one or more of a cycle rider height, a cycle rise inseam length, or one or more cycle rider customization inputs (e.g. a riding style preference). In certain embodiments, the external computing device includes a rider database storing a plurality of cycle rider profiles, the cycle rider profiles including position input data (e.g. height and/or inseam measurements) and personal electronic device data (e.g. account name and/or phone number used to reserve a cycle vehicle).

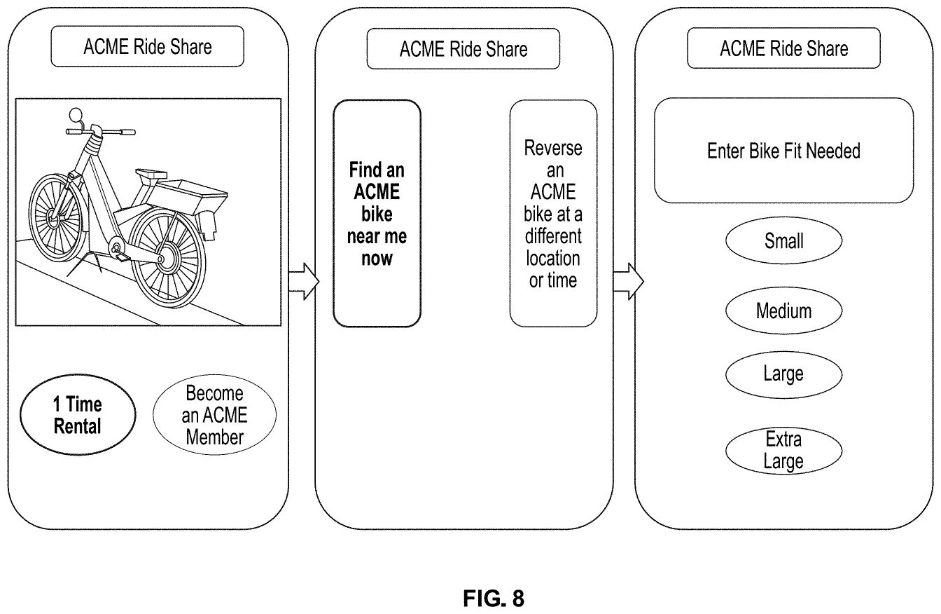

A vehicle user adjusting choices on the controller 39 may use selector switches allowing choosing up or down (or other input mechanisms), mounted in appropriate locations on the vehicle, or may be done via wireless signals (e.g. Bluetooth®) from a mobile device and/or another electronic device, include a personal electronic device. In some examples, any controller(s) may include a user interface with a display region (which may, in some examples, provide a graphical user interface with one or more elements similar in function and/or appearance as noted/illustrated for embodiments involving a personal electronic evidence, such as the interface shown in FIG. 8, and/or FIG. 9, and/or FIG. 10), and/or may include switches, knobs, or other input mechanisms with defined obtainable positions corresponding to various values (e.g. a knob position labeled with information indicating a minimum height, where the knob may be rotated in one direction to move up to the next height, and so one, for a plurality of positions). In some examples, any controller(s) may include a plurality of keys, for example keys arranged below and/or otherwise proximate to a display region, where the keys are configured for selection and complete of menu items or input areas displayed on the display region.

In some examples, a user can enter commands and/or information into through a controller input device(s), such as user interface provided by the controller. The user interface may be a touch sensitive display, such as a liquid crystal display (LCD) type interface, that allows a user to select various options on the user interface by applying pressure to the LCD screen in the region of the option selected. Each selection made by the user may prompt the user with another screen where further selections may be made.

Any controller(s) may include a processor and other appropriate computing components, positioned within a housing, which can be used to implement various aspects of the present disclosure. Example controller(s) may include a processing unit, a system memory, and/or a system bus that couples various system components including the system memory to the processing unit. The system bus may be any of several types of bus structures including a memory bus or memory controller, a peripheral bus, and a local bus using any of a variety of bus architectures.

In some examples, the one or more electronic controllers include at least one processor, a communication interface communicatively coupled to the at least one processor, and memory storing computer-readable instructions that, when executed by the at least one processor, cause the one or more electronic controllers to take actions resulting in adjustment of the cycle handlebars and/or seat. For example, the instructions, when executed, may cause the controller to establish a wireless data connection with an external computing device (e.g. a server with a rider profile database, or a rider's personal electronic device), receive position input data from the external computing device (e.g. a use's height, inseam, or other information such as preferred riding fit or style), identify an adjusted seat height based on the position input data. The adjusted height may be determined using one or more machine learning algorithms.

The instructions may further case the controller(s) to activate one or more motors to move the seat to the adjusted seat height, identify an adjusted handlebar height based on the position input data, activate the one or more motors to move the handlebars to the adjusted handlebar height. In some examples, position input data is a size selected by a cycle rider, e.g. small, medium, large, and so on (where this may correspond to a previously entered and stored size in the database). In certain embodiments, the position input data includes one or more of a cycle rider height, a cycle rise inseam length, or one or more cycle rider customization inputs (e.g. a riding style preference). In certain embodiments, the external computing device includes a rider database storing a plurality of cycle rider profiles, the cycle rider profiles including position input data (e.g. height and/or inseam measurements) and personal electronic device data (e.g. account name and/or phone number used to reserve a cycle vehicle). The position input data may be stored in the database, and then recovered and deployed to a vehicle simply by identifying the end user, for example by their mobile device (e.g. number) or other information tied to the device (e.g. an account name).

The controller may couple with a rider's personal device, e.g. a tablet, mobile device, or the like. This may be a direct connection or an indirect connection via another computing platform, e.g. a reservation platform or a rider profile platform. In some examples, some or all position input data is stored on the personal device for later use once entered. The controller may include or be connection to a vehicle communication component. In some examples, the vehicle commination components is a device provides a data connection that be interact with a personal electronic device and/or an external computing platform (e.g. a server with a rider database, a server storing vehicle information (such as location, which may be sent on an ongoing basis, and/or whenever a reservation is ended, and/or battery data to facilitate prompt maintenance and/battery replacement). The vehicle may include a portion of the frame and/or other component (such as part of the handlebars, e.g. the top of the handlebars) that includes a thermoplastic material to facilitate strong wireless communication. The vehicle communication component may be placed in the handlebars, within the frame, within a battery storage component/area, and/or other locations, and any internal wiring, for example to the controller, may be contained within the frame. The vehicle communication component may be integrated with or adjacent to the electronic controller.

In some examples, an external computing device may be an external computing platform, for example an external platform with a rider profile database. The external platform may be a computer system that includes one or more computing devices (e.g., servers, server blades, or the like) and/or other computer components (e.g., processors, memories, communication interfaces) that may be used to parse and package message information The external platform system may be a server, desktop computer, laptop computer, tablet, mobile device, or the like.

In some examples, a server may be configured to communicate with a plurality of vehicle controller(s), and/or a plurality of client personal electronic devices (e.g. tablets, mobile device such as mobile phones, or the like). Thus, the external computing platform (e.g. server) may facilitate the display of graphical user interfaces associated with the vehicle reservation application, electronic messaging service, or the like. The external computing platform (e.g. server) may also facilitate the input of, retrieval of, and/or transfer of position input data as illustrated herein. The external computing platform also may include one or more networks, which may interconnect to sub-platforms, such one or more of a messaging processing platform, rider database platform, vehicle location platform (that may be used to monitor and store the locations of vehicles during and after rider share reservations), or others. The one or more networks may also connection to a personal electronic device, e.g. a rider/client device. Some of all of these data connections may be wireless in nature. The computing platform may include a communication interface, which may be a network interface configured to support communication between a rider database platform and a client device. The memory may include one or more program modules having instructions that when executed by processor cause the computing platform to perform one or more functions described herein and/or one or more databases that may store and/or otherwise maintain information which may be used by such program modules and/or processors, e.g. rider information such as stored position input data, data regarding potential vehicles for reservation (e.g. location, battery life, etc.). In some instances, one or more program modules and/or databases may be stored by and/or maintained in different memory units and/or by different computing devices. Any components/connection described may apply to other computing devices (e.g. personal device, server, platform, and/or sub-platform).

Some aspects of the disclosure related to methods. In one aspect, a method of adjusting the positions of a seat and handlebars of a cycle vehicle is provided. The method, in some examples, includes receiving, at a computing platform having at least one processor, a communication interface, and memory, a vehicle reservation request from a personal electronic device. This may be an external platform, for example one housed entirely or partially on a server. Then, the computing platform may identify a cycle rider profile stored in a rider database provided in the memory, based on identifying information provided by the personal electronic device. The platform may then identify position input data based on the cycle rider profile, and then transmit the position input data to one or more electronic controllers of a cycle vehicle. In this manner, the cycle may then adjust the seat and/or handlebars of the cycle, for example prior to pick-up by the user, such that the vehicle is already adjusted and ready for comfortable use. In some examples, the method further includes transmitting a location of the cycle vehicle to the personal electronic device. In certain embodiments, the cycle rider profile includes one or more of a cycle rider height, a cycle rise inseam length, or one or more cycle rider customization inputs.

As noted above, the controller(s) may use input device(s) on the vehicle itself, e.g. switches mounted on the vehicle, but in certain embodiments a phone/electronic device application is used to display button selections to a user and, relying on wireless connections (such as but not limited to Bluetooth®) transfers any inputted data, for example to the vehicle. A displayed user interface may allow the user to enter their height and/or inseam. In some examples, one or more algorithms (that may be contained in the application data stored on the user's phone, and/or on a centralized platform, such as a server that communication with the personal electronic device of the user), may select/identify seat and handlebar positions for the rider, and in some examples the vehicle (e.g. the e-cycle) may preadjust itself for a good fit. Components and connections of the personal electronic device and/or external platform may correspond to any of the previously described components.

FIGS. 8, 9 and 10 are examples of possible mobile application displays/sequences used by a ride share company so customer can join and select a vehicle such that it will be auto-adjusted wirelessly for proper fit by the time customer gets to vehicle. Some or all of this content may be utilized in some embodiments, and the content/sequences may be provided in other mediums, such as directly on the vehicle controller and/or a vehicle display.

FIG. 8 is an example of the first steps an example display of ride share company app which can be downloaded to a mobile device, such that the customer can select a ride share vehicle time and location, and can select whether this is a one-time rental or whether they choose to be a member of the ride share company user group. In some examples, some or all of these selections are solicited and acquired. In the example of FIG. 8 the sequence of application pages shows a one-time user selection, and how they could select a size of fit for the vehicle. The vehicle controller could be programmed such that a specific height of seat and of handlebars would go with each of four size selections, for example, corresponding to four locations spaced equally (or, in some examples, not equally) throughout the range of possible positions. In other examples, other numbers of sizes are used. In other examples, and external platform conducts the determination of size positions.

In some examples, the handlebars and/or frame include a stand that may hold the personal electronic device (e.g. phone) to facilitate data entry and/or communication. In some examples, the stand (which may include one or more fastening components to be place over to the device to retain it within the stand, and/or create a friction fit) may be positioned to provide navigation data to the rider during user that is within and/or generally within the general field of view during typical rider use (e.g. is visible when looking forward in a typical manner).

In the example of FIG. 9, this shows an example application display page sequence from left to right for a new user who chooses to become a member rather than only a one-time user. This may correspond to the pages shown on a display of an electronic device, or on a GUI on an electronic controller on the vehicle. In this case the user chooses rider height, inseam and seating preference, which is then stored with their user name, and an appropriate seat height and handlebar height are sent to the controller on the ride share vehicle chosen by the user. The location of that vehicle may then be provided to the user. The vehicle may also receive personal electronic device information, such that it will only allow use by the authorized/reserved user, for example by identifying their phone and/or account name through a wireless connection, after receiving this information initially from an external platform such as a server. In some examples, the vehicle controller may interface with a personal device through a wireless connection and/or a server, but the user may still retain the ability to provide further adjustment on the vehicle itself through the controller (e.g. switches).

FIG. 10 shows an example application sequence for an existing user. As illustrated, the controller and/or application may allow a user to indicate whether a one-time use is desired, or whether a consistent membership is desired, or may provide an opportunity to provide login information (that may correspond with a stored rider profile).

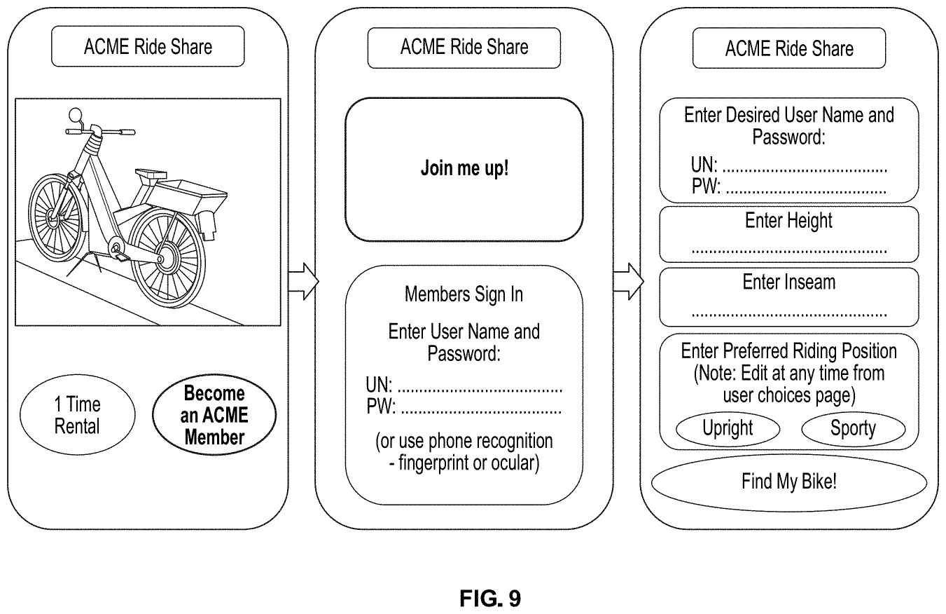

FIG. 11 shows example connectivity links between user, ride share company (e.g. a company operating a rider profile server and/or any other needed platforms), vehicle and adjustability actuators. Links may be wireless (e.g. based on wi-fi data connections, cellular data connections, Bluetooth® connections, radio frequency connections, etc.) or wired, or both. Additional components between illustrated components/platforms are possible, and other components/platforms may be part of such as system (e.g. rider profile database platform and a rider messaging platform may be part of the ride share office external platform).

In another method aspect, a method of adjusting the positions of a seat and handlebars of a cycle vehicle is provided. In some examples, the method includes receiving, at a computing platform comprising at least one processor and a communication interface, position input data (e.g. from a graphical user interface provided on the cycle, for example through a touchscreen and/or switches, or via a computing device that transmits user entered input). The method may then include adjusting a cycle seat from a first seat height to a second seat height, based on the position input data, by activating one or more motors powered by one or more power sources. The method may also include adjusting cycle handlebars from a first handlebar height to a second handlebar height, based on the position input data, by activating the one or more motors powered by the one or more power sources.

In some examples, the method further includes identifying, based on the position input data, the second seat height and the second handlebar height. In certain embodiments, the position input data includes one or more of a cycle rider height, a cycle rise inseam length, or one or more cycle rider customization inputs.

These method descriptions are merely examples. In certain embodiments, the method may include additional combinations or substitutions of some or all of the steps described above, or incorporate any of the controller and/or system features or aspects described herein. Moreover, additional and alternative suitable variations, forms and components for the method will be recognized by those skilled in the art given the benefit of this disclosure.

Likewise, any of the above apparatus/vehicle/vehicle component/platform descriptions are merely examples. In certain embodiments, the apparatuses/vehicles/vehicle components/platforms may include additional combinations or substitutions of some or all of the components and/or features described above. Moreover, additional and alternative suitable variations, forms and components will be recognized by those skilled in the art given the benefit of this disclosure.

The present disclosure is disclosed above and in the accompanying drawings with reference to a variety of examples. The purpose served by the disclosure, however, is to provide examples of the various features and concepts related to the disclosure, not to limit the scope of the same. One skilled in the relevant art will recognize that numerous variations and modifications may be made to the examples described above without departing from the scope of the present disclosure.

We claim:

1. A cycle vehicle comprising:
a seat assembly coupled to a cycle frame, the seat assembly comprising a seat positioned at a first seat height above a seat coupling;
a handlebar assembly coupled to the cycle frame, the handlebar assembly comprising handlebars positioned at a first handlebar height above a handlebar coupling;
one or more power sources; and
one or more motors;
wherein the seat assembly, the one or more power sources, and the one or more motors are configured to move the seat to at least a second seat height above the seat coupling; and
wherein the handlebar assembly, the one or more power sources, and the one or more motors are configured to move the handlebars to at least a second handlebar height above the handlebar coupling.

2. The cycle vehicle of claim 1, wherein the seat assembly, the one or more power sources, and the one or more motors are configured to move the seat linearly between the first seat height and the at least second seat height, and wherein the handlebar assembly, the one or more power sources, and the one or more motors are configured to move the handlebars linearly between the first handlebar height and the at least second handlebar height.

3. The cycle vehicle of claim 1, wherein the one or more motors are electric stepper motors.

4. The cycle vehicle of claim 1, wherein the one or more motors are configured to rotate a seat assembly threaded component to provide linear height adjustment of the seat, and wherein the one or more motors are configured to rotate a handlebar assembly threaded component to provide linear height adjustment of the handlebars.

5. The cycle vehicle of claim 1, wherein the handlebar assembly comprises two or more telescoping elongated members that are keyed together.

6. The cycle vehicle of claim 1, wherein the handlebar assembly comprises a fork coupling the handlebars and a wheel, wherein at least a portion of the fork provides a center defining a steering axis, wherein the first handlebar height and the at least second handlebar height are based on the position of a centerpoint of the handlebars, and wherein the first handlebar height and the at least second handlebar height are different positions along the steering axis or different positions along a handlebar centerpoint axis that is parallel to the steering axis.

7. The cycle vehicle of claim 1, wherein the handlebar assembly comprises a fork coupling the handlebars and a wheel, wherein at least a portion of the fork provides a center defining a steering axis, wherein the seat assembly comprises a seat extension coupling the seat and the frame, wherein at least a portion of the seat extension provides a center defining a seat axis, wherein the steering axis is offset by between twenty and thirty degrees from a perpendicular orientation to the ground when the cycle is upright and placed on a flat surface, and wherein the seat axis is offset by between twenty and thirty degrees from a perpendicular orientation to the ground when the cycle is upright and placed on a flat surface.

8. The cycle vehicle of claim 1, further comprising one or more electronic controllers, wherein the one or more controllers and one or more motors are configured to adjust the seat height and handlebar height, based on position input received by the one or more electronic controllers.

9. The cycle vehicle of claim 8, wherein the frame, seat assembly, and handlebar assembly are sized and shaped such that any wires, any cables, and any hoses used to connect the one or more electronic controllers, the one or more power sources, the one or more motors, and any brake components to each other are contained within an interior area provided by the frame, the seat assembly, and the handlebar assembly.

10. The cycle vehicle of claim 8, wherein the one or more electronic controllers are coupled to the frame, and are configured to receive position input through one or more controller inputs.

11. The cycle vehicle of claim 8, wherein the one or more electronic controllers are configured to interface with an external computing device through a wireless data connection and receive position input provided by the external computing device.

12. The cycle vehicle of claim 8, wherein the one or more electronic controllers comprise: at least one processor, a communication interface communicatively coupled to the at least one processor, and memory storing computer-readable instructions that, when executed by the at least one processor, cause the one or more electronic controllers to:
establish a wireless data connection with an external computing device;
receive position input data from the external computing device;
identify an adjusted seat height based on the position input data;
activate the one or more motors to move the seat to the adjusted seat height;
identify an adjusted handlebar height based on the position input data;
activate the one or more motors to move the handlebars to the adjusted handlebar height.

13. The cycle vehicle of claim 12, wherein the position input data is a size selected by a cycle rider.

14. The cycle vehicle of claim 12, wherein the position input data comprises one or more of a cycle rider height, a cycle rise inseam length, or one or more cycle rider customization inputs.

15. The cycle vehicle of claim 12, wherein the external computing device comprises a rider database storing a plurality of cycle rider profiles, the cycle rider profiles comprising position input data and personal electronic device data.

16. A method of adjusting the positions of a seat and handlebars of a cycle vehicle, the method comprising:
receiving, at a computing platform comprising at least one processor, a communication interface, and memory, a vehicle reservation request from a personal electronic device;
identifying a cycle rider profile stored in a rider database provided in the memory, based on identifying information provided by the personal electronic device;
identifying position input data based on the cycle rider profile;
transmitting the position input data to one or more electronic controllers of a cycle vehicle;
transmitting a location of the cycle vehicle to the personal electronic device.

17. The method of claim 16, wherein the cycle rider profile comprises one or more of a cycle rider height, a cycle rise inseam length, or one or more cycle rider customization inputs.

18. A method of adjusting the positions of a seat and handlebars of a cycle vehicle, the method comprising:
receiving, at a computing platform comprising at least one processor and a communication interface, position input data;
adjusting a cycle seat from a first seat height to a second seat height, based on the position input data, by activating one or more motors powered by one or more power sources; and
adjusting cycle handlebars from a first handlebar height to a second handlebar height, based on the position input data, by activating the one or more motors powered by the one or more power sources.

19. The method of claim 18, further comprising identifying, based on the position input data, the second seat height and the second handlebar height.

20. The method of claim 18, wherein the position input data comprises one or more of a cycle rider height, a cycle rise inseam length, or one or more cycle rider customization inputs.
